(19) United States
(12) Patent Application Publication
(10) Pub. No.: US 2019/0375183 A1
(43) Pub. Date: Dec. 12, 2019

(54) MULTI LAYER CAR MAT LINER

(71) Applicant: Debbie Cates, Los Lunas, NM (US)

(72) Inventor: Debbie Cates, Los Lunas, NM (US)

(21) Appl. No.: 16/434,130

(22) Filed: Jun. 6, 2019

Related U.S. Application Data
(60) Provisional application No. 62/682,888, filed on Jun. 9, 2018.

(51) Int. Cl. B32B 3/26; B32B 5/02; B32B 25/02; B32B 5/26; B32B 29/02; B32B 7/05; B32B 7/06

(52) U.S. Cl. CPC B32B 3/263; B32B 5/026; B32B 5/028; B32B 25/02; B32B 2307/724; B32B 29/02; B32B 7/05; B32B 7/06; B32B 2605/003; B32B 5/26

(57) ABSTRACT

Disclosed herein is a multi-layer car mat liner. Further, the multi-layer car mat liner may include a first layer. Further, the first layer may include a knitted nylon fabric sheet. Further, a top surface of the first layer may include a plurality of longitudinal channels. Further, the plurality of longitudinal channels may be configured to trap particulate matter. Further, a second layer of the multi-layer car mat liner may include an absorbent sheet configured to absorb moisture. Further, a third layer of the multi-layer car mat liner may be a fiberglass mesh. Further, a fourth layer of the multi-layer car mat liner may be a thin sheath of rubber. Further, a bottom surface of the fourth layer may be configured to secure the multi-layer car mat liner to a vehicle floor.

### TECHNICAL FIELD

Generally, the present disclosure relates to the field of floor mats for vehicles. More specifically, the present disclosure relates to a multi-layer car mat liner.

### BACKGROUND

For millions of vehicle owners, car mats have provided protection for the vehicle's carpeting against mud, water, melting snow and ice, and spilled beverages. Car mats, quite simply, preserve the resale value of the vehicle. This is particularly true in regions such as the Pacific Northwest, with extensive periods of precipitation. Conventional car mats usually include a single layer of rubber or carpet fabric that is not capable of preventing the moisture from reaching the floor of the vehicle. Unfortunately, under more extreme conditions the conventional car mat has proven to be inadequate.

Therefore, there is a need for improved multi-layer car mat liner that may overcome one or more of the above-mentioned problems and/or limitations.

### BRIEF SUMMARY

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a multi-layer car mat liner. Accordingly, the multi-layer car mat liner may include a first layer. Further, the first layer may be a top layer of the multi-layer car mat liner. Further, the first layer may include a knitted nylon fabric sheet. Further, a top surface of the first layer may include a plurality of longitudinal channels. Further, the plurality of longitudinal channels may be configured to trap particulate matter. Further, the multi-layer car mat liner may include a second layer. Further, the second layer may include an absorbent sheet configured to absorb moisture. Further, a top surface of the second layer may be bonded to a bottom surface of the first layer. Further, the multi-layer car mat liner may include a third layer. Further, the third layer may be a fiberglass mesh. Further, a top surface of the third layer may be bonded to a bottom surface of the second layer. Further, the multi-layer car mat liner may include a fourth layer. Further, the fourth layer may be a thin sheath of rubber. Further, a top surface of the fourth layer may be bonded to a bottom surface of the third layer. Further, a bottom surface of the fourth layer may be configured to secure the multi-layer car mat liner to a vehicle floor.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a top view of a multi-layer car mat liner, in accordance with some exemplary embodiment.

FIG. 2 is a bottom view of a multi-layer car mat liner, in accordance with some exemplary embodiment.

FIG. 3 is an exploded top perspective view of a multi-layer car mat liner, in accordance with some exemplary embodiment.

FIG. 4 is an exploded bottom perspective view of a multi-layer car mat liner, in accordance with some exemplary embodiment.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of a multi-layer car mat liner, embodiments of the present disclosure are not limited to use only in this context.

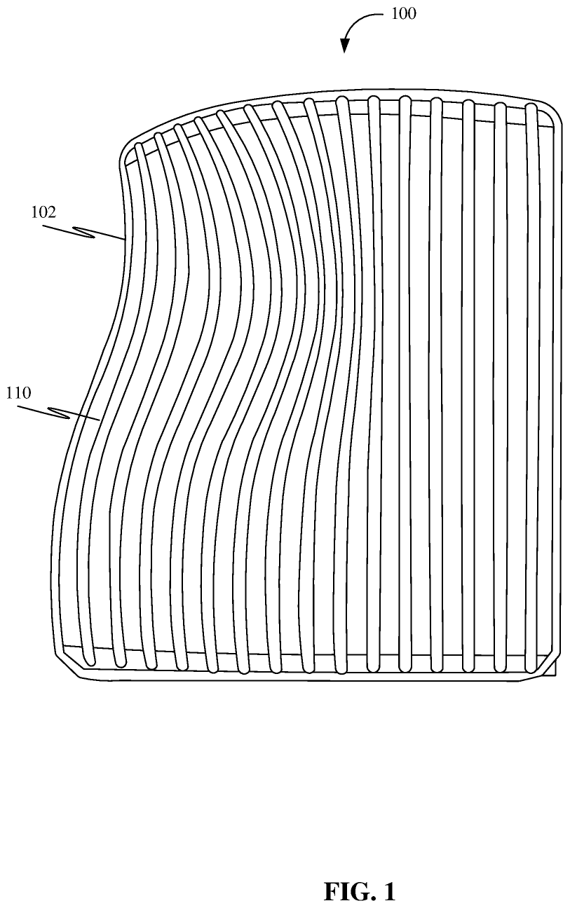

FIG. 1 is a top view of a multi-layer car mat liner 100, in accordance with some exemplary embodiment. Accordingly, the multi-layer car mat liner 100 may include a first layer 102. Further, the first layer 102 may be a top layer of the multi-layer car mat liner 100. Further, the first layer 102 may include a knitted nylon fabric sheet. Further, a top surface of the first layer 102 may include a plurality of longitudinal channels 110. Further, the plurality of longitudinal channels 110 may be configured to trap particulate matter. Further, in some embodiments, the particulate matter may include at least one of dirt, debris, litter, scrap, and sand.

Further, the multi-layer car mat liner 100 may include a second layer 104. Further, the second layer 104 may include an absorbent sheet configured to absorb moisture. Further, a top surface of the second layer 104 may be bonded to a bottom surface of the first layer 102. Further, in some embodiments, the second layer 104 may include a Purafilter® 2000.

Further, the multi-layer car mat liner 100 may include a third layer 106. Further, the third layer 106 may be a fiberglass mesh. Further, in some embodiments, the fiberglass mesh may further include puppy pee pads. Further, a top surface of the third layer 106 may be bonded to a bottom surface of the second layer 104. Further, in some embodiments, the third layer 106 may be configured to stop the particulate matter from reaching a vehicle floor.

Further, the multi-layer car mat liner 100 may include a fourth layer 108. Further, the fourth layer 108 may be a thin sheath of rubber. Further, a top surface of the fourth layer 108 may be bonded to a bottom surface of the third layer 106. Further, a bottom surface of the fourth layer 108 may be configured to secure the multi-layer car mat liner 100 to the vehicle floor. Further, in some embodiments, the fourth layer 108 may include non-adhesive high friction rubber material configured to prevent the multi-layer car mat liner 100 from skidding over the vehicle floor.

Further, in some embodiments, the multi-layer car mat liner 100 may be having a substantially rectangular shape of a predetermined surface area. Further, the substantially rectangular shape may be configured to cover a specified portion of the vehicle floor.

Further, in some embodiments, each of the first layer 102, the second layer 104, the third layer 106, and the fourth layer 108 may be permanently bonded at outer edges of each of the first layer 102, the second layer 104, the third layer 106, and the fourth layer 108.

Further, in some embodiments, each of the first layer 102, the second layer 104, the third layer 106, and the fourth layer 108 may be configured to be removably bonded with each other using a removable attachment mechanism. Further, the removable attachment mechanism, in an instance, may include (but not limited to) a hook fastener, a Velcro fastener, a magnetic fastener, nut/bolt, and so on.

Further, in some embodiments, the first layer 102 and the fourth layer 108 may be manufactured using at least one of a plastic, a rubber, and a silicon. Further, in some embodiments, the second layer 104 and the third layer 106 are manufactured using at least one of a paper, and a woven cotton fiber.

Further, in some embodiments, at least one of the first layer 102, the second layer 104, the third layer 106, and the fourth layer 108 may include an aromatic component. Further, the aromatic component may be a scent configured to be emitted continuously into a surrounding environment of the multi-layer car mat liner 100 for a predetermined period after the multi-layer car mat liner 100 may be exposed to the surrounding environment. Further, in some embodiments, the predetermined period may include one or more months. Further, in some embodiments, the aromatic component may include at least one of an oil-based scent, and a water-based scent.

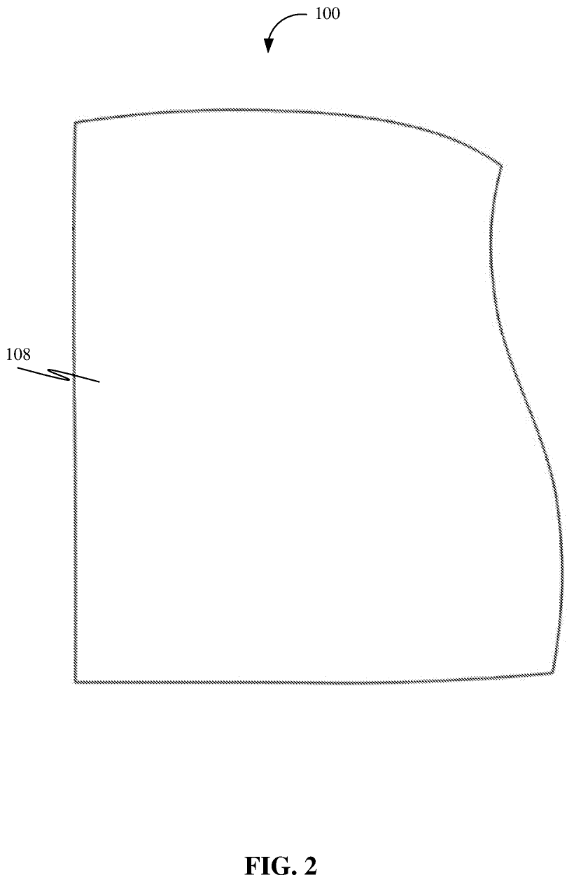

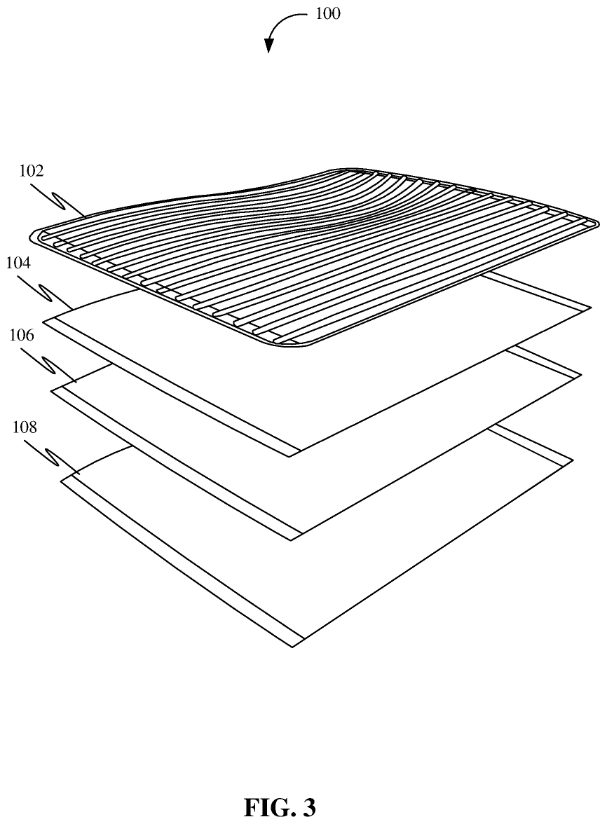

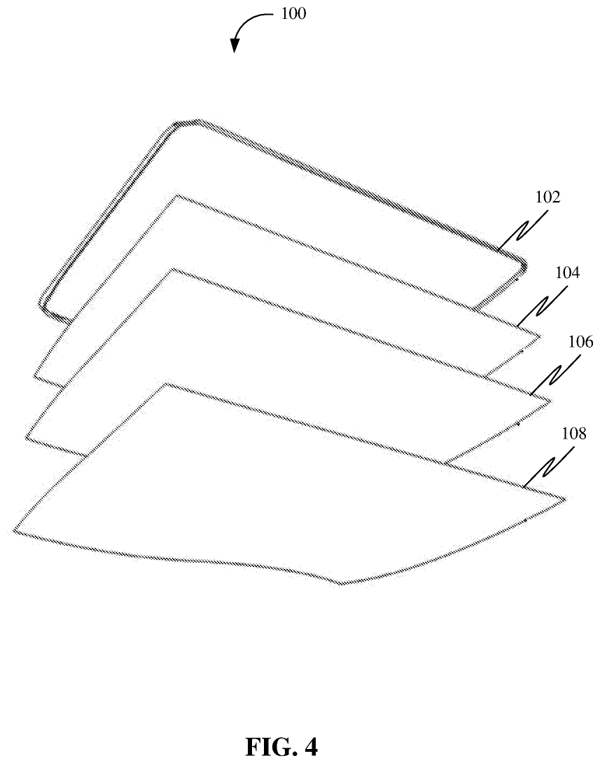

Further, FIG. 2 is a bottom view of the multi-layer car mat liner 100, in accordance with some exemplary embodiment. Further, FIG. 3 is an exploded top perspective view of the multi-layer car mat liner 100, in accordance with some exemplary embodiment. Further, FIG. 4 is an exploded bottom perspective view of the multi-layer car mat liner 100, in accordance with some exemplary embodiment.

Further, in some embodiments, a car mat liner (such as the multi-layer car mat liner 100) may provide four principal layers. Accordingly, a top layer (such as the first layer 102) may provide longitudinal channels, which trap dirt, sand, and other particulate matter. Further, a first middle layer (such as the second layer 104) may be highly absorbent and may absorb a substantial amount of moisture. Further, a second middle layer (such as the third layer 106) may have a lower degree of absorbency, and may stop any dirty material from reaching a car mat. Further, under the second middle layer is a thin sheath (such as the fourth layer 108) of high friction rubber, which may secure the car mat liner to a top surface of the car mat.

Further, to use the car mat liner, a user may place the car mat liner on top of the user's car mat. If the car mat liner becomes soiled, the user may simply discard and replace the car mat liner.

Further, the top layer and the sheath may be preferably manufactured from a flexible, disposable material, which may provide a high friction surface, such as plastic, rubber, or silicon. Further, the first middle layer and the second middle layer may be preferably manufactured from a flexible, disposable material, such as paper or woven cotton fibers.

Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

Although the present disclosure has been explained in relation to its preferred embodiment, it is to be understood that many other possible modifications and variations can be made without departing from the spirit and scope of the disclosure.

What is claimed is:

1. A multi-layer car mat liner comprising:
a first layer, wherein the first layer is a top layer of the multi-layer car mat liner, wherein the first layer comprises a knitted nylon fabric sheet, wherein a top surface of the first layer comprises a plurality of longitudinal channels, wherein the plurality of longitudinal channels are configured to trap particulate matter;
a second layer, wherein the second layer comprises an absorbent sheet configured to absorb moisture, wherein a top surface of the second layer is bonded to a bottom surface of the first layer;
a third layer, wherein the third layer is a fiberglass mesh, wherein a top surface of the third layer is bonded to a bottom surface of the second layer; and
a fourth layer, wherein the fourth layer is a thin sheath of rubber, wherein a top surface of the fourth layer is bonded to a bottom surface of the third layer, wherein a bottom surface of the fourth layer is configured to secure the multi-layer car mat liner to a vehicle floor.

2. The multi-layer car mat liner of claim 1, wherein the particulate matter comprises at least one of dirt, debris, litter, scrap, and sand.

3. The multi-layer car mat liner of claim 1, wherein the first layer and the fourth layer are manufactured using at least one of a plastic, a rubber, and a silicon.

4. The multi-layer car mat liner of claim 1, wherein the second layer and the third layer are manufactured using at least one of a paper, and a woven cotton fiber.

5. The multi-layer car mat liner of claim 1 having a substantially rectangular shape of a predetermined surface area, wherein the substantially rectangular shape is configured to cover a specified portion of the vehicle floor.

6. The multi-layer car mat liner of claim 1, wherein the third layer is configured to stop the particulate matter from reaching the vehicle floor.

7. The multi-layer car mat liner of claim 1, wherein the fiberglass mesh further comprises puppy pee pads.

8. The multi-layer car mat liner of claim 1, wherein the second layer comprises a Purafilter® 2000.

9. The multi-layer car mat liner of claim 1, wherein the fourth layer comprises non-adhesive high friction rubber material configured to prevent the multi-layer car mat liner from skidding over the vehicle floor.

10. The multi-layer car mat liner of claim 1, wherein each of the first layer, the second layer, the third layer, and the fourth layer is permanently bonded at outer edges of each of the first layer, the second layer, the third layer, and the fourth layer.

11. The multi-layer car mat liner of claim 1, wherein each of the first layer, the second layer, the third layer, and the fourth layer is configured to be removably bonded with each other using a removable attachment mechanism.

12. The multi-layer car mat liner of claim 1, wherein at least one of the first layer, the second layer, the third layer, and the fourth layer comprises an aromatic component, wherein the aromatic component is a scent configured to be emitted continuously into a surrounding environment of the multi-layer car mat liner for a predetermined period after the multi-layer car mat liner is exposed to the surrounding environment.

13. The multi-layer car mat liner of claim 12, wherein the predetermined period comprises one or more months.

14. The multi-layer car mat liner of claim 12, wherein the aromatic component comprises at least one of an oil-based scent, and a water-based scent.
